(19) United States
(12) Patent Application Publication
(10) Pub. No.: US 2010/0117559 A1
(43) Pub. Date: May 13, 2010

(54) Illumination Apparatus and Driving Method Thereof

(76) Inventor: Young Hwan Lee, Seoul (KR)

Correspondence Address: THE LAW OFFICES OF ANDREW D. FORTNEY, PH.D., P.C., 215 W FALLBROOK AVE SUITE 203, FRESNO, CA, 93711, US

(21) Appl. No.: 12/615,155

(22) Filed: Nov. 9, 2009

Related U.S. Application Data
(60) Provisional application No. 61/113,536, filed on Nov. 11, 2008.
(60) Provisional application No. 61/113,539, filed on Nov. 11, 2008.

(30) Foreign Application Priority Data
Nov. 11, 2008 (KR) 10-2008-0111896
Nov. 11, 2008 (KR) 10-2008-0111897

(51) Int. Cl. H05B 37/02; H05B 41/36

(52) U.S. Cl. 315/294; 315/291; 313/504

(57) ABSTRACT

An illumination apparatus includes an adapter that converts power into driving power; a light emitting device illumination part that is detachably and electrically connected to the adapter to emit light according to the driving power from the adapter; and a driving unit that controls an illumination direction of the light emitting device.

The present application claims priority under 35 U.S.C. §119(e) of Korean Patent Application Nos. 10-2008-0111896 (filed on Nov. 11, 2008) and 10-2008-0111897 (filed on Nov. 11, 2008), and U.S. Provisional Application Nos. 61/113,539 (filed on Nov. 11, 2008) and 61/113,536 (filed on Nov. 11, 2008), which are hereby incorporated by reference in their entireties.

### BACKGROUND

### Description of the Related Art

Embodiments of the invention relate to an illumination apparatus and a driving method thereof.

At the present time, a fluorescent lamp or an incandescent lamp has been widely used as an illumination apparatus. In particular, the fluorescent lamp has low power consumption and high brightness so that it has been widely used at office or at home.

Meanwhile, an illumination apparatus that replaces the fluorescent lamp or the incandescent lamp has been recently developed and, representatively, an illumination apparatus using a light emitting diode (LED) has been introduced.

However, in the case of the illumination apparatus using the LED, it is driven with different voltage from the fluorescent lamp or the incandescent lamp, causing a problem that all of power supply apparatus including conventionally installed sockets should be replaced when using the illumination apparatus using the LED.

### SUMMARY OF THE INVENTION

Embodiments of the invention provide an illumination apparatus with a new structure using a LED or an OLED, and a driving method thereof.

Various embodiments provide an illumination apparatus using the LED or the OLED that can be used without replacing a power supply apparatus installed for a conventional fluorescent lamp, an incandescent lamp, a halogen lamp, etc.

Various embodiments provide an illumination apparatus that can compatibly use various light emitting device illumination units by detachably installing an adapter and a light emitting device illumination unit.

Various embodiments provide an illumination apparatus that can control an illumination direction of the apparatus in a desired direction.

Various embodiments provide an illumination apparatus capable of increasing a length between light emitting device illumination parts or changing illumination directions of the light emitting device illumination part, if necessary, by installing an elastic connection part between adjacent light emitting device illumination part sections.

An illumination apparatus according to the embodiments includes an adapter that converts alternating power into driving power; a light emitting device illumination part that is configured to be detachably and electrically connected to the adapter and configured to emit light according to the driving power from the adapter; and a driving unit that is configured to control an illumination direction of the light emitting devices in the light emitting device illumination part.

An illumination apparatus according to the embodiments includes an adapter that converts alternating power into driving power; a light emitting device illumination part including a plurality of light emitting device modules that is configured to be detachably and electrically connected to the adapter and to emit light according to the driving power from the adapter; and a connection part between adjacent light emitting device modules.

A method of driving an illumination apparatus according to various embodiments includes converting alternating power into driving power in an adapter; emitting light from a light emitting device illumination part according to the driving power, the light emitting device illumination part being detachably and electrically connected to the adapter; and controlling an illumination direction of the light emitting device illumination part in a driving unit that is connected to the adapter.

### BRIEF DESCRIPTION OF THE DRAWINGS

FIG. 1 is a diagram explaining an illumination apparatus according to a first embodiment.

FIG. 2 is a perspective view of the illumination apparatus according to the first embodiment.

FIG. 3 is a diagram showing an operation example of the illumination apparatus according to the first embodiment.

FIG. 4 is a diagram explaining an adapter in the illumination apparatus according to the first embodiment.

FIG. 5 is a diagram showing the AC-DC converter of the adapter in the illumination apparatus according to the first embodiment.

FIG. 6 is a diagram for explaining another embodiment of an illumination apparatus according to the first embodiment.

FIG. 7 is a diagram for explaining an illumination apparatus according to a second embodiment.

FIG. 8 is a perspective view of the illumination apparatus according to the second embodiment.

FIG. 9 is a perspective view for explaining another embodiment of the illumination apparatus according to the second embodiment.

FIG. 10 is a diagram showing a use of another embodiment of the illumination apparatus according to the second embodiment.

FIG. 11 is a partially enlarged view of a connection part and a light emitting module in the illumination apparatus according to the second embodiment.

FIG. 12 is a cross-sectional view of the connection part in the illumination apparatus according to the second embodiment.

FIG. 13 is a diagram for explaining in an adapter in the illumination apparatus according to the second embodiment.

### DETAILED DESCRIPTION OF THE EMBODIMENTS

In the drawings, the thickness or size of each layer is exaggerated, omitted or schematically illustrated for the convenience and clarity of explanation. Also, the size of each constituent does not completely reflect its actual size.

Hereinafter, an illumination apparatus according to embodiments will be described with reference to the accompanying drawings.

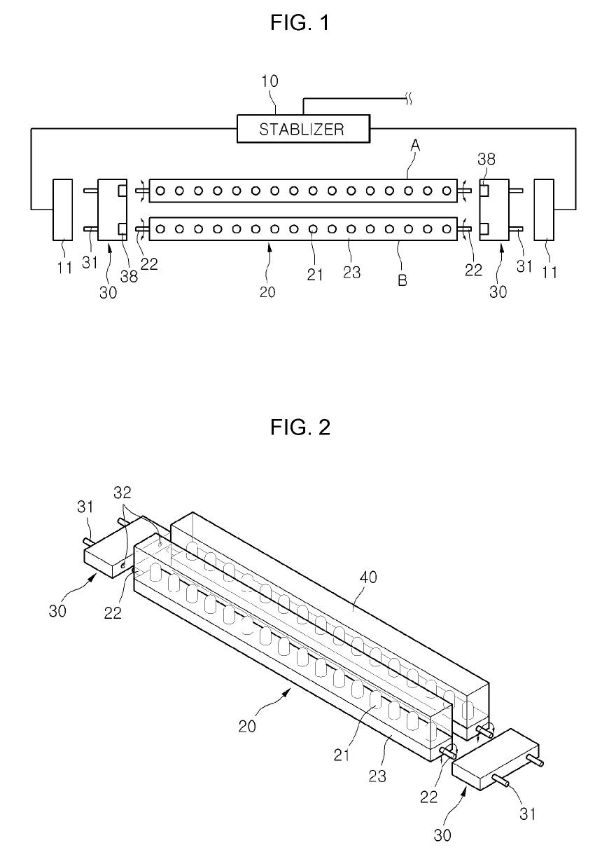

FIG. 1 is a diagram for explaining an illumination apparatus according to a first embodiment, and FIG. 2 is a perspective view of the illumination apparatus according to the first embodiment.

First, referring to FIGS. 1 and 2, the illumination apparatus according to the first embodiment includes a power terminal 22 formed at both ends of a substrate 23, a light emitting device illumination part 20 having a plurality of light emitting devices 21 on the upper surface of the substrate 23, and an adapter coupled at opposite sides of the light emitting device illumination part 20. Moreover, a cover 40 that protects the light emitting devices 21 may further be installed on the substrate 23.

The light emitting device illumination part 20 may be configured of a plurality of modules in a plurality of panel shapes, for example, module A, module B, etc., but is not limited thereto.

In the light emitting device illumination part 20, the plurality of light emitting devices 21 are arranged on the substrate 23. The light emitting devices 21 may be LED or OLED.

The substrate 23 may be a printed circuit board (PCB) on which a circuit pattern for providing power to the light emitting devices 21 is formed. Also, the substrate 23 may be a substrate that a wiring for providing power to the light emitting devices 21 is installed on a plastic instrument.

Moreover, a reflective coating layer (not shown) may be formed on the surface of the substrate 23, making it possible to increase efficiency of light emitted from the light emitting devices 21 by coating it with silver (Ag) or aluminum (Al).

The plurality of light emitting devices 21 may include LED or OLED that light-emit red, blue, and green, and may also include LED or OLED that light-emit white.

The cover 40 may be formed of transparent plastic material, and may also be formed of plastic with various colors such as red, green, blue, etc., as needed. Also, the cover 40 may be formed of translucent material and in this case, it may also provide an illumination with a soft atmosphere.

The power terminal 22 that can be electrically connected to the adapter 30 are installed at opposite ends of the substrate 23, thereby supplying power to the light emitting devices 21 from the outside.

One side of the adapter 30 is provided with a connector 31 that is inserted into the socket 11 for installing a conventional fluorescent lamp, and the other side thereof is provided with a power terminal groove 32 into which the power terminal 22 of the light emitting device illumination part 20 are inserted.

The light emitting device illumination part 20 is coupled to the adapter 30 so that the illumination apparatus according to the first embodiment can be installed at the socket 11 where a conventional fluorescent lamp is installed. Therefore, although a power supply apparatus including the socket 11 where the conventional fluorescent lamp is installed is not replaced, an illumination apparatus using LED or OLED can be used.

In particular, since the light emitting device illumination part 20 and the adapter 30 are detachably installed, when defects are generated on the light emitting device illumination part 20 or the adapter 30, only the light emitting device illumination part 20 or the adapter 30 where the defects are generated can be replaced, having low maintenance costs.

Moreover, since the light emitting device illumination part 20 and the adapter 30 are detachably installed, illuminations with various atmospheres can be provided by replacing only the light emitting device illumination part 20.

In addition, the first embodiment may form the light emitting device illumination part 20 in the plurality of panel shapes and may further include a driving unit 38 that can rotatably drive the light emitting device illumination part 20. The driving unit 38 may be formed in the adapter 30 and can generate power by a motor, etc., but is not limited thereto. Therefore, the illumination apparatus according to the first embodiment can face the light emitting device illumination part 20 to a desired direction, making it possible to control the illumination direction.

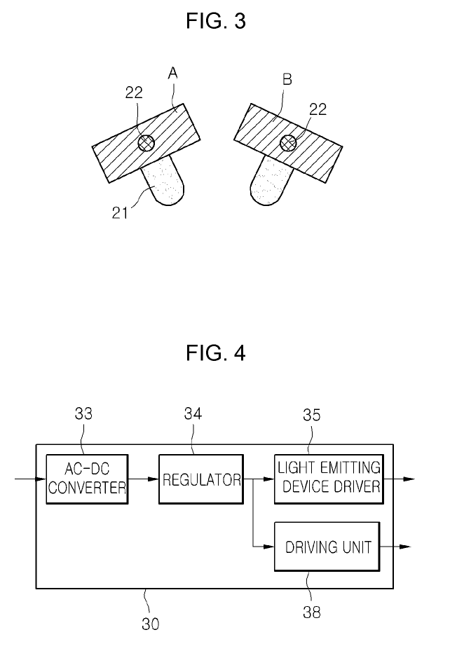

FIG. 3 is a diagram showing an operation example of the illumination apparatus according to the first embodiment. FIG. 3 shows an example that the illumination can be concentrated by facing each of the first module and the second module of the light emitting device illumination part 20 to the same direction. Unlike this, the illumination can be concentrated on a wider area by facing the first module and the second module to different directions.

Referring to FIG. 4, the adapter 30 includes an AC-DC converter 33, a regulator 34, a light emitting device driver 35, and a driving unit 38. The AC-DC converter 33 converts AC power supplied through the socket 11 into DC power, the regulator 34 allows the DC power output from the AC-DC converter 33 to be output as constant DC voltage, and the light emitting device driver 35 outputs the DC voltage supplied from the regulator 34 as driving pulse proper in driving the plurality of light emitting devices 121. For example, as shown in FIG. 4, the adapter 30 includes a bridge rectifier 33a and a smoothing circuit 34a to allow constant DC voltage to be output. The driving unit 38 may be formed in the adapter 30 and can generate power by a motor, etc., but is not limited thereto.

Therefore, the light emitting device illumination part 20 can also be used in the power supply apparatus for the conventional fluorescent lamp to which the AC power is supplied by the adapter 30 that includes the AC-DC converter 33, the regulator 34, the light emitting device driver 35, and the driving unit 38.

In other words, as shown in FIG. 1, the power supply apparatus for the fluorescent lamp includes a stabilizer 10 that converts commercial power into high frequency current of 20-50 kHz and two sockets 11 connected to the stabilizer 10, wherein only high frequency AC current is provided through the sockets 11 so that the light emitting device illumination part 20 cannot be installed directly on the conventional power supply apparatus.

However, the illumination apparatus according to the first embodiment installs the adapter 30, making it possible to use the light emitting device illumination part 20, while using the conventional power supply apparatus as it is.

Moreover, since the adapter 30 and the light emitting device illumination part 20 are detachable, the illumination apparatus can be used to be connected to only the light emitting device illumination part 20 by separating the adapter 30 from the light emitting device illumination part 20 where the power supply apparatus for the light emitting device illumination part 20 is installed.

FIG. 6 is a diagram for explaining another embodiment of the illumination apparatus according to the first embodiment and shown an example that the light emitting device illumination part 20 is formed in a single module. Thereby, the illumination apparatus can be effectively used in an environment where providing the illumination direction to perform the concentrating illumination is effective.

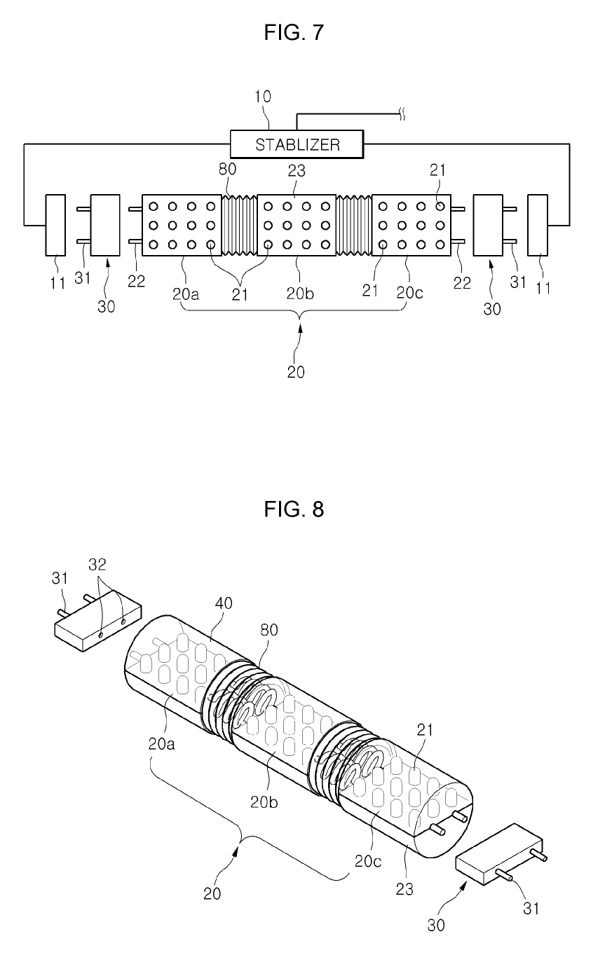

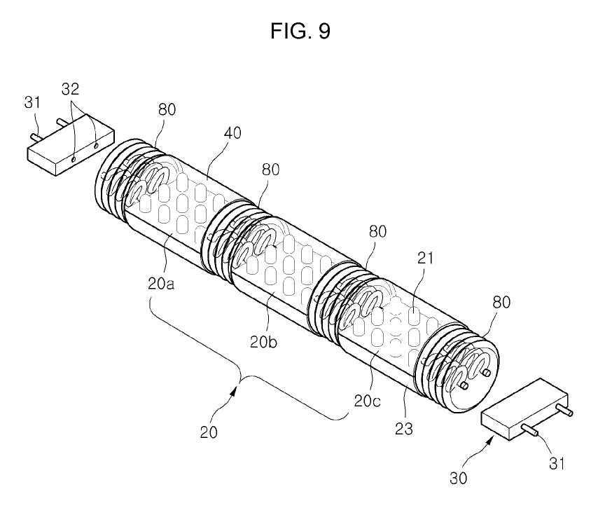

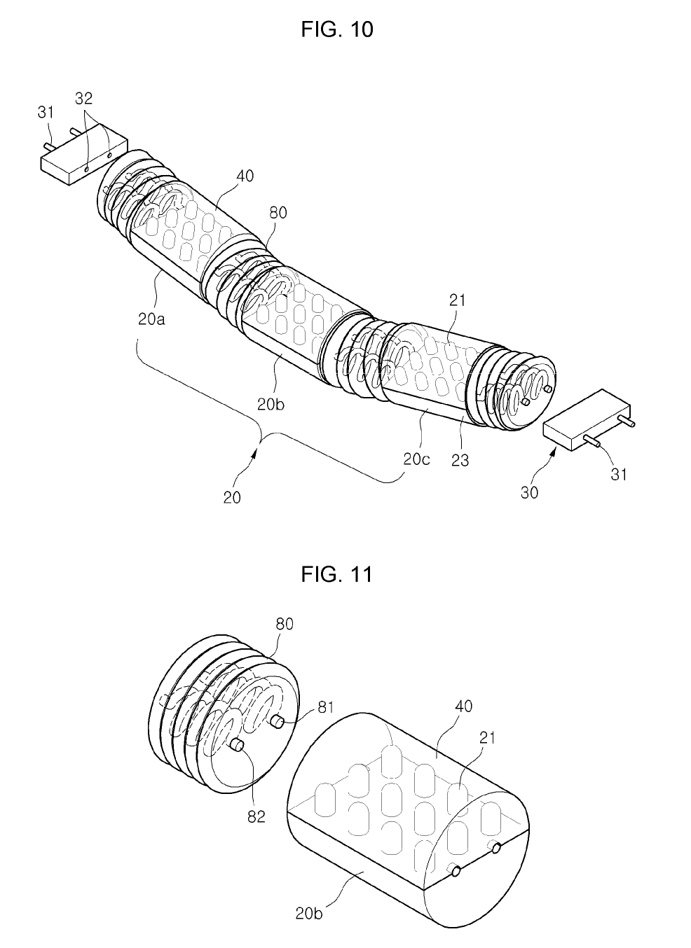

FIG. 7 is a diagram for explaining an illumination apparatus according to a second embodiment, FIG. 8 is a perspective view of the illumination apparatus according to the second embodiment, FIG. 9 is a perspective view for explaining another embodiment of the illumination apparatus according to the second embodiment, and FIG. 10 is a diagram showing a use of the illumination apparatus according to the second embodiment.

Referring first to FIGS. 7 and 8, the illumination apparatus according to the second embodiment includes the light emitting device illumination part 20. The light emitting device illumination part 20 includes a first light emitting device module 20a, a second light emitting device module 20b, and a third light emitting device module 20c and includes a connection part 80 between the plurality of light emitting device modules that are illustrated as the first light emitting device module 20a, the second light emitting device module 20b, and the third light emitting device module 20c.

Each of the first light emitting device module 20a, second light emitting device module 20b, and third light emitting device module 20c includes the substrate 23 and the light emitting device 21 that is installed on the substrate 23 and the power terminal 22 is formed at opposite ends of the substrate 23 that is connected to the adapter 30. The light emitting device 21 may be an LED or an OLED.

Further, a cover 40 for protecting the light emitting device 21 may be further installed on the substrate 23.

The substrate 23 may be a printed circuit board (PCB) on which a circuit pattern for providing power to the light emitting device 21 is formed. In addition, the substrate 23 may be a substrate that a wiring for providing power to the light emitting devices 21 is installed on a plastic instrument.

In addition, a reflective coating layer (not shown) may be formed on the surface of the substrate 23, making it possible to increase efficiency of light emitted from the light emitting devices 21 by coating it with silver (Ag) or aluminum (Al).

The plurality of light emitting devices 21 may include an LED or an OLED that can light-emit red, blue, and green and an LED or an OLED that can light-emit white.

The cover 40 may be made of a transparent plastic material and may be made of plastic having various colors such as red, green, blue, etc., if necessary. In addition, the cover may be formed of a translucent material and in this case, it may also provide an illumination with a soft atmosphere.

The power terminal 22 that can be electrically connected to the adapter 30 are installed at opposite ends of the substrate 23, thereby supplying power to the light emitting devices 21 from the outside.

One side of the adapter 30 is provided with a connector 31 that is inserted into the socket 11 for installing a conventional fluorescent lamp, and the other side thereof is provided with a power terminal groove 32 into which the power terminal 22 of the light emitting device illumination part 20 are inserted.

The illumination apparatus according to the second embodiment may be installed in the socket in which the existing fluorescent lamp is installed by connecting the light emitting device illumination unit 20 and the adapter 30. Therefore, embodiments can use the illumination apparatus using the LED or the OLED without replacing the power supply apparatus including the socket 11 in which the existing fluorescent lamp is installed.

In particular, since the light emitting device illumination unit 20 and the adapter 30 are detachably installed, when defects are generated on the light emitting device illumination unit 20 or the adapter 30, only the light emitting device illumination unit 20 or the adapter 30 where the defects are generated can be replaced, having low maintenance costs.

Moreover, since the light emitting device illumination unit 20 and the adapter 30 are detachably installed, illuminations with various atmospheres can be provided by replacing only the light emitting device illumination unit 20.

Further, as shown in FIG. 9, another embodiment of the illumination apparatus according to the second embodiment further includes a connection part 80 between the light emitting device modules 20a and 20c and the adapter 30 at opposite sides of the adapter 30, making it possible to further increase the length of the illumination apparatus.

As shown in FIG. 10, the second embodiment installs the elastic connection part 80 between the plurality of light emitting device modules 20a, 20b, and 20c, making it possible to provide the illumination apparatus that can increase the length of the illumination apparatus if necessary.

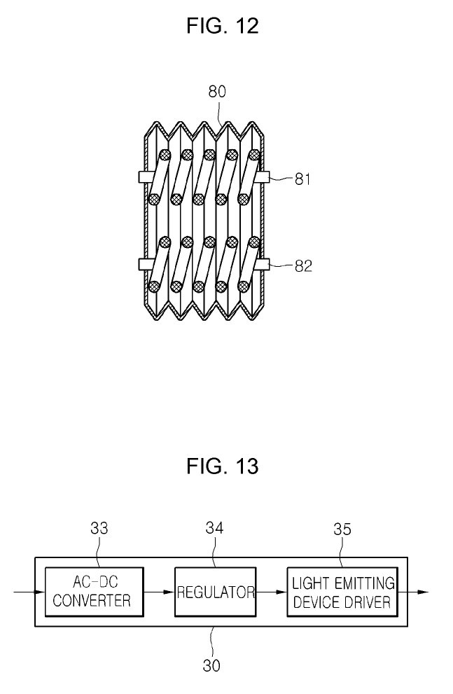

FIG. 11 is a partially enlarged view of the connection part and the light emitting module in the illumination apparatus according to the second embodiment, and FIG. 12 is a cross-sectional view of the connection part in the illumination apparatus according to the second embodiment.

As shown in FIGS. 11 and 12, the connection part 80 may include conductors 81 and 82 that connect the plurality of light emitting modules 20a, 20b, and 20c. For example, the conductors 81 and 82 may be an elastic conductor in a spring shape that connects the plurality of light emitting devices 20a, 20b, and 20c, but are not limited thereto. In the second embodiment, the illumination apparatus can be used by extending the connection part 80 according to the environment where the illumination apparatus is used. At this time, when the conductors 81 and 82 of the connection part 80 are made of a metal with elasticity and conductivity, for example, a material such as iron (Fe), the illumination apparatus is extended and can be then recovered to an original shape.

On the other hand, when the conductors 81 and 82 are made of a material without elasticity but with conductivity, for example, copper (Cu), etc., the illumination apparatus is extended in a required shape and then, the illumination apparatus can be used in the extended state, without the influence of the external environment.

Further, when the conductors 81 and 82 of the connection part 80 are made of a shape memory alloy, etc., the illumination apparatus is used in the extended state if necessary and when the connection part 80 is then applied with heat, etc., it is recovered to an original state, making it possible to use the illumination apparatus in an original state that is not extended.

In the second embodiment, the connection part 80 may further include a nonconductor that surrounds the conductors 81 and 82. For example, the connection part 80 includes an opaque nonconductor such as rubber, etc., to surround the conductors 81 and 82, but is not limited thereto.

The second embodiment installs the elastic connection part 80 between the plurality of light emitting device modules 20a, 20b, and 20c, making it possible to increase the length of the illumination apparatus if necessary.

Referring to FIG. 13, the adapter 30 includes the AC-DC converter 33, the regulator 34, and the light emitting device driver 35.

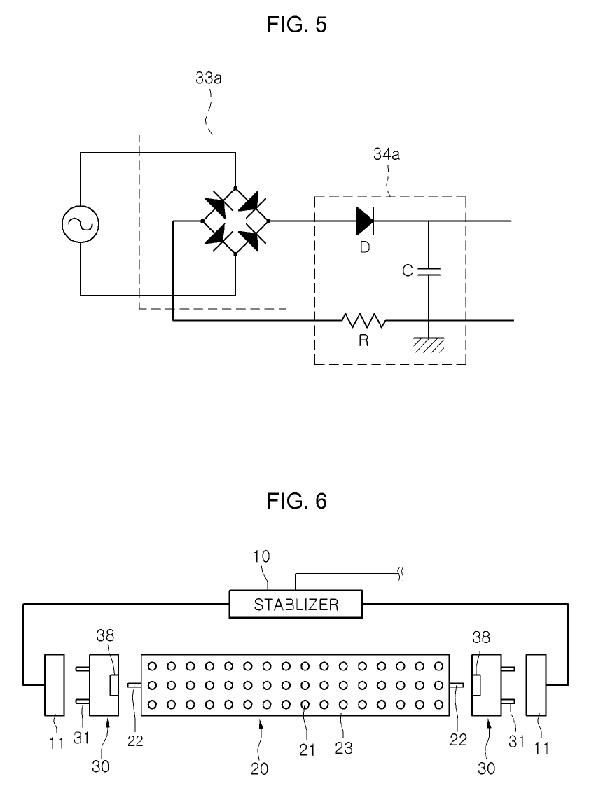

The AC-DC converter 33 converts AC power supplied through the socket 11 into DC power, the regulator 34 allows the DC power output from the AC-DC converter 33 to be output as constant DC voltage, and the light emitting device driver 35 outputs the DC voltage supplied from the regulator 34 as one or more driving pulses, sufficient or proper to drive the plurality of light emitting devices 121. For example, as shown in FIG. 5, the adapter 30 includes a bridge rectifier 33a and a smoothing circuit 34a to allow constant DC voltage to be output.

Therefore, the light emitting device illumination part 20 can also be used in the power supply apparatus for the conventional fluorescent lamp to which the AC power is supplied by the adapter 30 that includes the AC-DC converter 33, the regulator 34, and the light emitting device driver 35.

Embodiments of the invention can provide the illumination apparatus having a new structure using the LED or the OLED.

Various embodiments can provide the illumination apparatus using the LED or the OLED that can be used, without replacing the power supply apparatus installed for the existing fluorescent lamp, incandescent lamp, a halogen lamp, etc.

Various embodiments can provide the illumination apparatus that can compatibly use various light emitting device illumination units by detachably installing the adapter and a light emitting device illumination unit.

Various embodiments can provide an illumination apparatus that can control an illumination direction in a desired direction.

Various embodiments can provide an illumination apparatus capable of increasing a length between light emitting device illumination parts or changing illumination directions of the light emitting device illumination part by installing an elastic connection part (e.g., between adjacent light emitting device illumination part sections).

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is within the purview of one skilled in the art to effect such feature, structure, or characteristic in connection with other embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An illumination apparatus, comprising:
an adapter that converts alternating power into driving power;
a light emitting device illumination part configured to be detachably and electrically connected to the adapter and configured to emit light according to the driving power from the adapter; and
a driving unit that controls an illumination direction of the light emitting device illumination part.

2. The illumination apparatus according to claim 1, wherein the driving unit is in the adapter.

3. The illumination apparatus according to claim 1, wherein the light emitting device illumination part has a plurality of panels.

4. The illumination apparatus according to claim 1, wherein the adapter includes:
an AC-DC converter that converts AC voltage into DC voltage;
a regulator that receives the DC voltage from the AC-DC converter and outputs a constant DC voltage; and
a light emitting device driver that outputs the constant DC voltage from the regulator as one or more driving pulses.

5. The illumination apparatus according to claim 1, wherein the adapter includes:
a connection terminal configured to be connected to a fluorescent lamp socket; and
a power terminal groove or socket configured to be connected to a power terminal of the light emitting device illumination part.

6. The illumination apparatus according to claim 1, wherein the light emitting device illumination part includes:
a substrate;
a plurality of light emitting device drivers on the substrate; and
a power terminal at each of opposite ends of the substrate and configured to be coupled to the adapter.

7. The illumination apparatus according to claim 6, wherein the light emitting device includes a light-emitting diode (LED) or an organic light-emitting diode (OLED).

8. An illumination apparatus, comprising:
an adapter that converts alternating power into driving power;
a light emitting device illumination part including a plurality of light emitting device modules configured to be detachably and electrically connected to the adapter and configured to emit light according to the driving power from the adapter; and
a connection part that between adjacent ones of the plurality of light emitting device modules.

9. The illumination apparatus according to claim 8, wherein the connection part includes a conductor that connects the adjacent light emitting device modules.

10. The illumination apparatus according to claim 9, wherein the conductor is an elastic conductor.

11. The illumination apparatus according to claim 9, wherein the conductor is a non-elastic conductor.

12. The illumination apparatus according to claim 9, wherein the conductor is a shape memory conductor.

13. The illumination apparatus according to claim 8, wherein the connection part is between the light emitting device module and the adapter.

14. The illumination apparatus according to claim 8, wherein the adapter includes:
an AC-DC converter that converts an AC voltage into a DC voltage;
a regulator that receives the DC voltage from the AC-DC converter and outputs a constant DC voltage; and
a light emitting device driver that outputs the constant DC voltage from the regulator as one or more driving pulses.

15. The illumination apparatus according to claim 8, wherein the adapter includes:
a connection terminal configured to be connected to a fluorescent lamp socket; and
a power terminal groove or socket configured to be connected to the power terminal of the light emitting device illumination part.

16. The illumination apparatus according to claim 8, wherein the light emitting device illumination part includes:
a substrate;
a plurality of light emitting devices on the substrate; and
a power terminal at each of opposite ends of the substrate, configured to be coupled to the adapter.

17. The illumination apparatus according to claim 16, wherein the light emitting device includes a light-emitting diode (LED) or an organic light-emitting diode (OLED).

18. A method of driving an illumination apparatus, comprising:
converting alternating power into driving power in an adapter;
emitting light from a light emitting device illumination part according to the driving power, the light emitting device illumination part being detachably and electrically connected to the adapter; and
controlling an illumination direction of the light emitting device illumination part in a driving unit that is connected to the adapter.

19. The method according to claim 18, wherein the light emitting device illumination part comprises a plurality of sections, and the illumination direction of each section is controlled by the driving unit.

20. The method according to claim 18, wherein the light emitting device illumination part includes a plurality of light-emitting diode (LED) or organic light-emitting diode (OLED) light emitting devices.
